(19) United States
(12) Patent Application Publication
(10) Pub. No.: US 2022/0126224 A1
(43) Pub. Date: Apr. 28, 2022

(54) APPARATUS FOR RESIN EXTRACTION

(71) Applicant: Charles MacGowan, Miami, FL (US)

(72) Inventor: Charles MacGowan, Miami, FL (US)

(21) Appl. No.: 17/571,457

(22) Filed: Jan. 8, 2022

(51) Int. Cl. B01D 11/02

(52) U.S. Cl. CPC B01D 11/0219; B01D 11/0288; B01D 11/0207

(57) ABSTRACT

The present invention discloses an apparatus for effective and efficient extraction of resin from plant materials. The apparatus includes at least an agitator and a tank. The tank is a square tank and is made of one piece of plastic that is sloped and folded (V-shaped) at the bottom. The agitator includes a single impellor or pulsator having two sides. The pulsator creates fluid currents in an upwards and downwards direction. Top portion pushes fluid up and bottom portion pushes fluid down. As a result of agitation, trichomes get separated and pass-through openings of the false bottom surface and are collected on the V-shaped bottom surface. This collection of the trichomes on the V-shaped bottom surface ensures that the trichomes do not move or go upward. The false bottom surface ensures that the trichomes are not getting hit by the agitator again post their collection on the V-shaped bottom surface.

### FIELD OF THE INVENTION

The present application generally relates to processing of plant materials, and more particularly to an apparatus for effective and efficient extraction of resin particulates from plant materials such as botanical flowers.

### BACKGROUND

Many plants concentrate resin in glandular structures called trichomes on the outside of leaves or flowers. These can be mechanically separated from the plant or flower matter to collect the resin without the use of solvents. Various devices or methods are known in the art for separating resins from plant materials. Typical methods for extracting resins from plant materials utilize chemical solvents along with filter media to dissolve and separate the desired resins from the plant materials. These methods require additional processes to remove the chemicals from the collected resins. These extraction chemicals may constitute substantial costs and liabilities to provide, handle, apply and dispose of, and risk altering the resins in undesirable ways or producing undesirable residue. Another method for extracting the plant resins utilizes a water bath along with filter media to suspend and then separate the desired resins from the plant materials. This method requires additional processes to remove the water from the collected resins after percolation through the filters.

Generally, drum machines are known way for extracting the resins from the plants. Basically, drum machines are comprised of a cylinder wherein plant materials are placed in the cylinder for soaking and then it is turned on along its axis. As the cylinder turns, the resins fall through the mesh of the cylinder into a collection area. While the drum machines may be automated, there may still be a certain level of skill required for extracting highly concentrated resins. All of these use various combinations of temperature, pressure, agitation, and time to facilitate the extraction processes. In view of the foregoing, a need exists for an apparatus for efficiently and effectively extracting the resins from the plant materials. More specifically, a need exists for apparatus and related methods of improved drumming machines for removing resins from the plant materials.

### SUMMARY

It will be understood that this disclosure is not limited to a particular apparatus, configurations, and methodologies described herein, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

It is an object of the present invention to provide an apparatus or a machine for effective and efficient extraction of resin particulates from plant materials such as botanical flowers. The apparatus includes at least an agitator and a tank.

The tank is a square tank and is made of one piece of plastic that is sloped and folded (V-shaped) at the bottom. The tank includes a false bottom surface (stainless steel plate with predefined patterns of openings) and a sloped V-shaped bottom surface. The tank has been designed in a way that it can be easily separated and replaced by another tank. This increases the overall efficiency of the resin extraction process.

The agitator is a machine that is used in the tank for mixing various process media together. Media include all liquid types, gases, or solids (such as water, ice, flowers, etc.), or any combination thereof. In summary, it works by rotating an impeller or pulsator to impart energy to the media which interact and mix. Generally, the agitator goes inside the tank and creates one or more types of motions that causes extraction of trichomes from the flowers or any other biomass under consideration. The agitator includes a single impellor or pulsator having two sides. The pulsator creates fluid currents in an upwards and downwards direction. Top portion pushes fluid up and bottom portion pushes fluid down.

In process, a lid of the tank is opened, a bag is placed inside the tank, and then flowers or biomass is kept inside the bag. Further, a suitable amount of cold water and optionally ice is mixed with the flowers or biomass. Then, the lid is closed and/or pressed for allowing the flowers or biomass to soak into the cold water, ice, or any combination thereof. After soaking, the agitator is used to agitate or mix the soaked flowers or biomass. As a result of agitation, the trichomes get separated and pass-through openings of the false bottom surface (i.e., the metallic plate) and are collected on the V-shaped bottom surface. This collection of the trichomes on the V-shaped bottom surface ensures that the trichomes do not move or go upward. The false bottom surface ensures that the trichomes are not getting hit by the agitator again post their collection on the V-shaped bottom surface. Once all the trichomes have been collected, the tank may be replaced with another tank including soaked flowers or biomass. This process may continue to increase the overall efficiency of trichomes extraction.

These and other features and advantages of the present invention will become apparent from the detailed description below, considering the accompanying drawings.

### BRIEF DESCRIPTION OF ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIGS. 1 and 2 are diagrams that illustrate an overall working arrangement of an apparatus for extracting resin from plant materials, according to an exemplary embodiment of the present invention.

FIGS. 3 and 4 are diagrams that illustrate a square tank of the apparatus, according to an exemplary embodiment of the present invention.

FIG. 5 is a diagram that illustrates a lid of the tank, according to an exemplary embodiment of the present invention.

FIGS. 6 and 7 are diagrams that illustrate a bag for use with the tank, according to an exemplary embodiment of the present invention.

FIGS. 8 and 9 are diagrams that illustrate retractable mechanism of the lid, according to an exemplary embodiment of the present invention.

FIGS. 10 and 11 are diagrams that illustrate the retractable mechanism of the lid inside the tank, according to an exemplary embodiment of the present invention.

FIG. 12 is a diagram that illustrates a pulsator of an agitator of the apparatus, according to an exemplary embodiment of the present invention.

FIG. 13 is a diagram that illustrates plant processing and trichomes extraction, according to an exemplary embodiment of the present invention.

FIG. 14 is a diagram that illustrates collection of trichomes, according to an exemplary embodiment of the present invention.

FIG. 15 is a diagram that illustrates turbulence distribution in the square tank during the agitation, according to an exemplary embodiment of the present invention.

FIG. 16 is a diagram that illustrates a front view of the tank, according to an exemplary embodiment of the present invention.

FIGS. 17 and 18 are diagrams that illustrate an inside view of the tank, according to an exemplary embodiment of the present invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes an apparatus or a machine for extraction of resin particulates from plant materials such as botanical flowers. Many plants concentrate resin in glandular structures called trichomes on the outside of leaves or flowers. These can be separated from the plant or flower matter to collect the resin without the use of organic solvents. The apparatus disclosed herein may be used for extracting the trichomes from the plant materials. Accordingly, the components have been represented, showing only specific details that are pertinent for understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

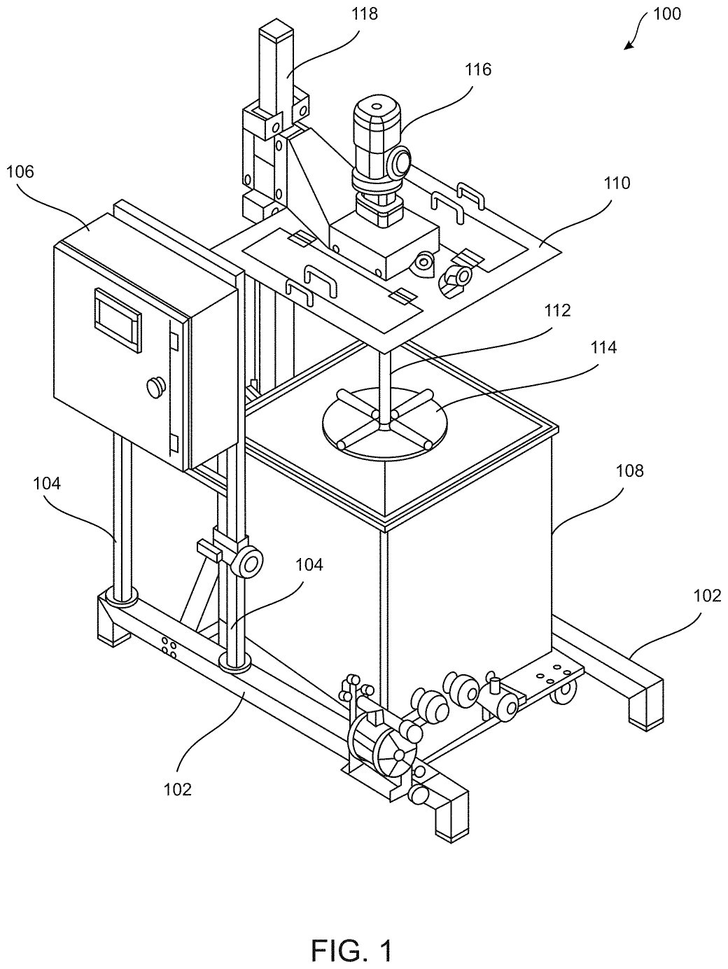

The apparatus or machine for resin extraction will now be described with reference to the accompanying drawings FIGS. 1-18, which should be regarded as merely illustrative without restricting the scope and ambit of the present invention.

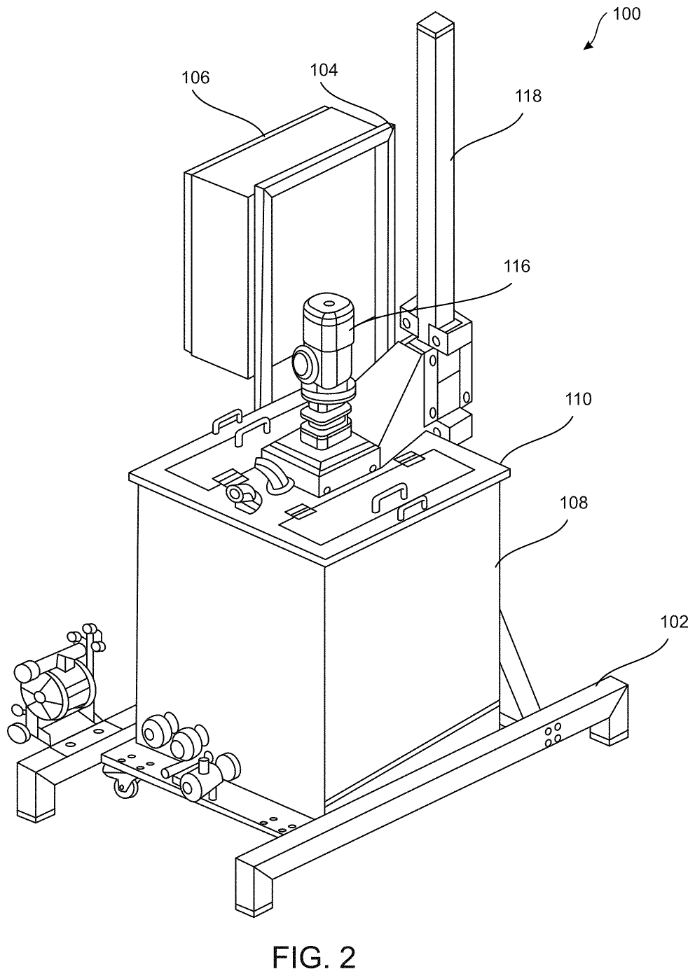

FIGS. 1 and 2 are diagrams 100 that illustrate an overall working arrangement of an apparatus for extracting resin from plant materials, according to an exemplary embodiment of the present invention. The apparatus includes a plurality of legs 102, a plurality of vertical supports 104, an electronic controller 106, and a tank 108. The tank 108 is a square tank and is made of one piece of plastic that is sloped and folded (V-shaped) at the bottom. The vertical supports 104 are attached to a leg 102. The electronic controller 106 is attached to a top portion of the vertical supports 104 as shown. The electronic controller 106 includes one or more control switches such as a switch to turn ON or OFF one or more components of the apparatus such as motor(s) or agitator(s). The electronic controller 106 further includes one or more LED lights to indicate a status of the apparatus. The electronic controller 106 further includes a display that is configured to display one or more measured parameters such as speed of motor(s) of the agitator, inside temperature of the tank 108, a weight of the collected trichomes, or the like.

The apparatus further includes a lid 110 with an agitator having a shaft 112, a pulsator 114, and a motor 116. The motor 116 (when turned ON) drives the shaft 112 which drives the pulsator 114. This lid 110 is attached to another vertical support 118 by means of a fastening mechanism known in the art. The lid 110 and hence the agitator can be adjusted along the vertical support 118 so that the agitator moves up or down as per the needs. The agitator is a machine that is used in the tank 108 for mixing various process media together. Media include all liquid types, gases, or solids (such as water, ice, flowers, etc.), or any combination thereof. In summary, it works by rotating an impeller or pulsator 114 to impart energy to the media which interact and mix. Generally, a portion (i.e., the pulsator 114 and a portion of the shaft 112) of the agitator goes inside the tank 108 and creates one or more types of motions that causes extraction of trichomes from the flowers, plant materials, or any other biomass. The agitator includes a single impellor or pulsator having two sides. The pulsator 114 creates fluid currents in an upwards and downwards direction. Top portion 114a pushes fluid up and bottom portion 114b pushes fluid down.

In operation, a bag (shown later) is placed inside the tank 108, and then flowers or plant materials are kept inside the bag. Further, a suitable amount of cold water and optionally ice is mixed with the flowers or plant materials. The suitable amount of cold water to be used for the soaking process may be dependent upon a quantity and/or quality of flowers or plant materials being used during the soaking process. Further, optionally, a suitable amount of ice may be added to the mixture of cold water and flowers or plant materials if the water being used is not cold enough for the soaking process. Once the flowers or plant materials are mixed well with the cold water and/or the ice, the flowers or plant materials are left for some time to soak into the cold water, ice, or any combination thereof. After soaking, the agitator is used to agitate or mix the soaked flowers or plant materials. Here, a portion of the agitator (i.e., the pulsator 114 and a portion of the shaft 112) goes inside the tank 108 and creates one or more types of motions that causes extraction of trichomes from the flowers, or any other plant materials soaked in the tank 108. As a result of agitation, the trichomes get separated and pass-through openings of a false bottom surface (shown later) and are collected on a V-shaped bottom surface (shown later) of the tank 108. This collection of the trichomes on the V-shaped bottom surface ensures that the trichomes do not move or go upward. The false bottom surface ensures that the trichomes are not getting hit by the agitator again post their collection on the V-shaped bottom surface. Once all the trichomes have been collected, the tank 108 may be replaced with another tank including soaked flowers or plant materials. This way a user may not have to put the whole setup on halt. The user can simply replace one tank with another tank. This process may continue to increase the overall efficiency of trichomes extraction. Further, the overall investment and expense is optimized.

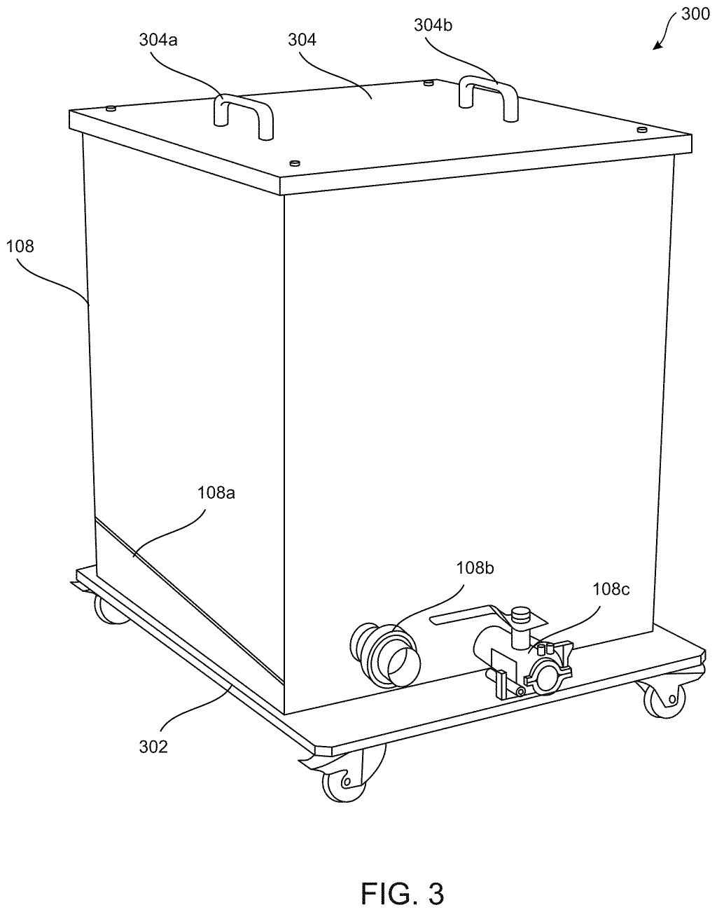

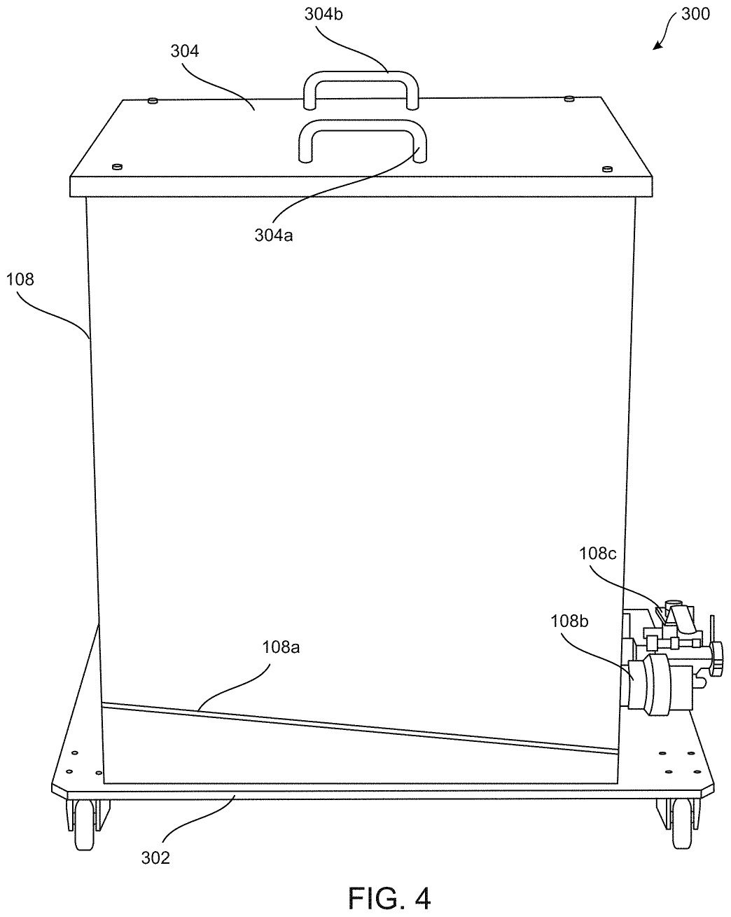

FIGS. 3 and 4 are diagrams 300 that illustrate the square tank 108 of the apparatus, according to an exemplary embodiment of the present invention. The tank 108 is a square tank and is made of one piece of plastic that is sloped and folded (V-shaped) at the bottom (described later in detail). The tank 108 is supported by a horizontal tray with wheels at the bottom as shown by 302. The tank 108 includes a lid 304 that is used to close or cover a top portion of the tank 108. The lid 304 includes two handles 304a and 304b. The handles are used to insert or remove the lid 304 into or from the tank 108. The tank 108 further includes a sloped lining portion 108a that indicates the sloped nature of the bottom surface. The tank 108 further includes a sight glass 108b that can be used to inspect the inside of the tank 108. The tank 108 further includes a drain valve 108c that can be used to drain out the collected trichomes. Generally, one end of a pipe is connected to a drain valve opening and another end is used for collecting the trichomes in a collection vessel. When a latch of the drain valve 108c is opened, the trichomes move or flow from the tank 108 via the pipe to the collection vessel.

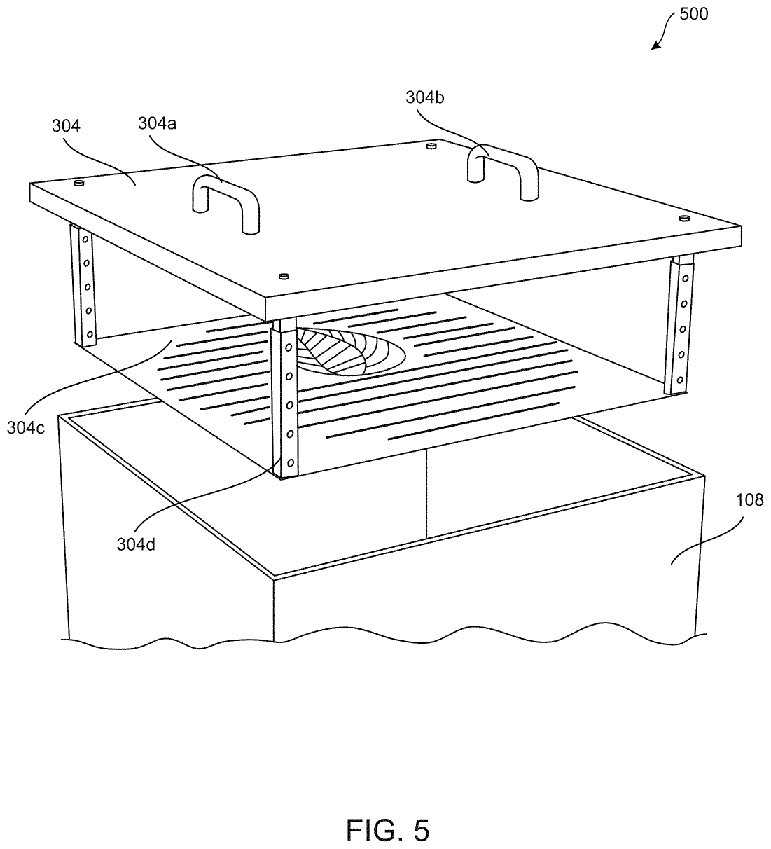

FIG. 5 is a diagram 500 that illustrates the lid 304 of the tank 108, according to an exemplary embodiment of the present invention. The lid 304 includes two handles 304a and 304b. The lid 304 further includes four stretchable or retractable or expandable legs 304d. The lid 304 further includes a stainless-steel plate 304c having one or more patterns of openings. The lid 304 may be used for compressing plant materials (i.e., flowers) into the mixture of cold water and ice inside the tank 108 so that the plant materials are soaked properly.

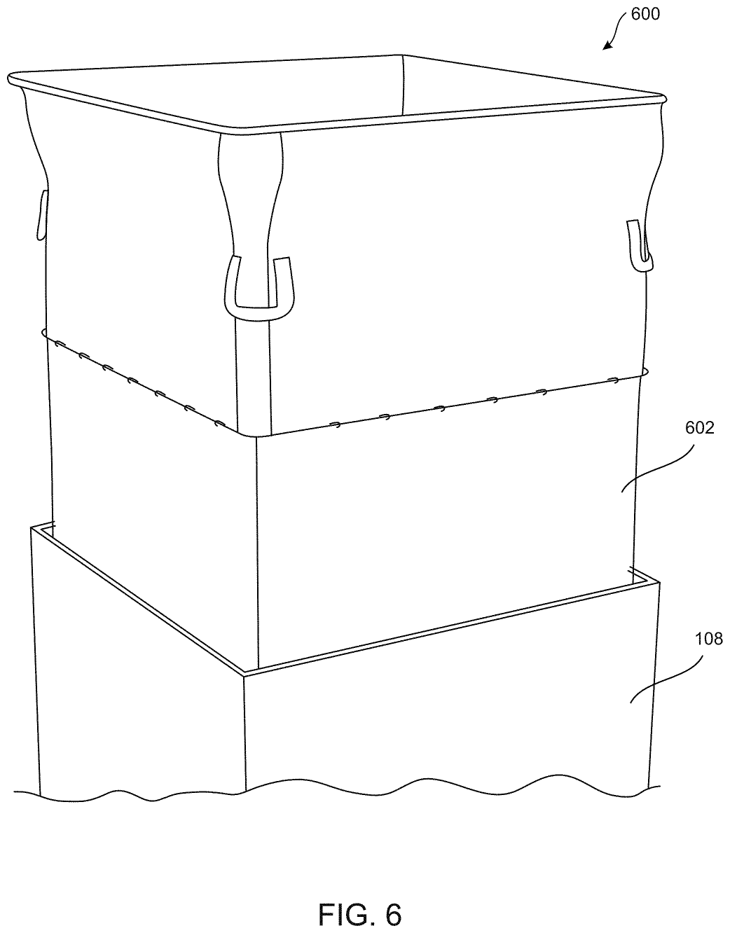

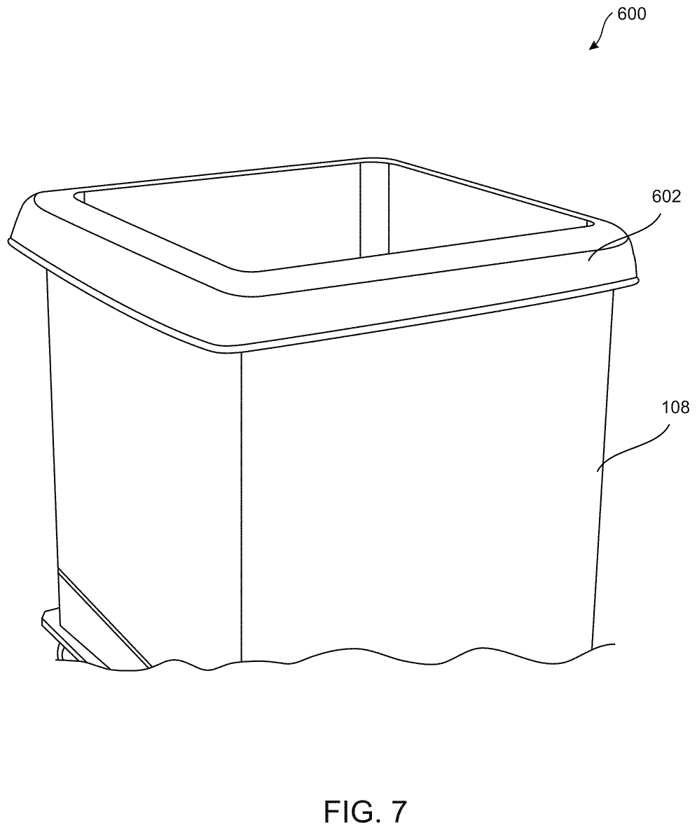

FIGS. 6 and 7 are diagrams 600 that illustrate a bag 602 for use with the tank 108, according to an exemplary embodiment of the present invention. The bag 602 is a strainer basket comprising walls constructed from a mesh material selected based on a type of plant materials to be processed. The bag 602 may be removeable from the tank 108, and may comprise a plurality of mounting tabs extending outwardly from an upper rim of the bag 602 for suspending the bag 602 within the tank 108. The bag 602 may comprise a plurality of hanging straps extending outwardly from a upper portion of the bag 602 for suspending the bag 602 out of the tank 108. For maximum durability, the bag 602 may be made of superior food grade nylon mesh and nylon canvas but should not be construed as limiting to the scope of the present invention. Each bag has string latches or other fastener that allows it to fit securely around the tank 108.

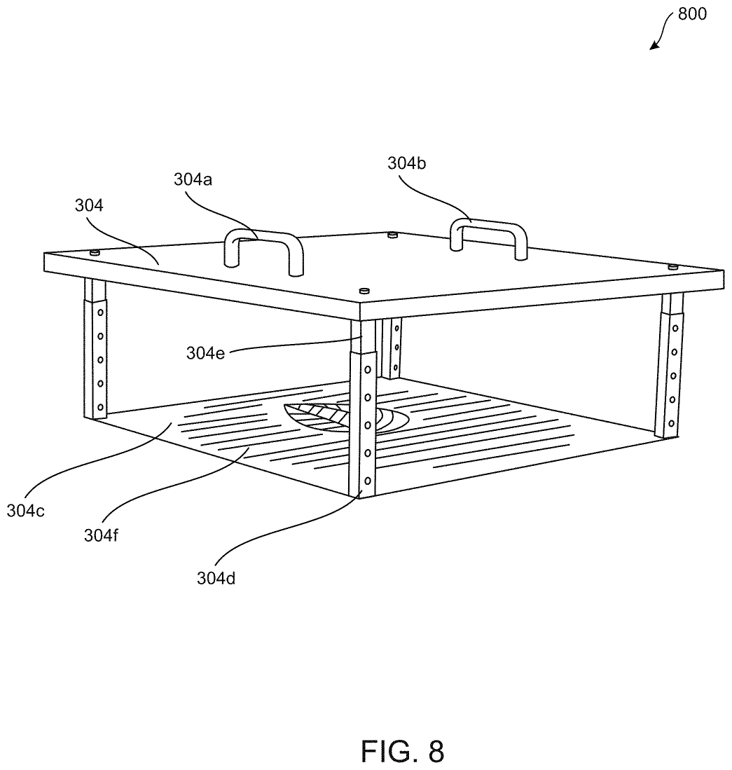

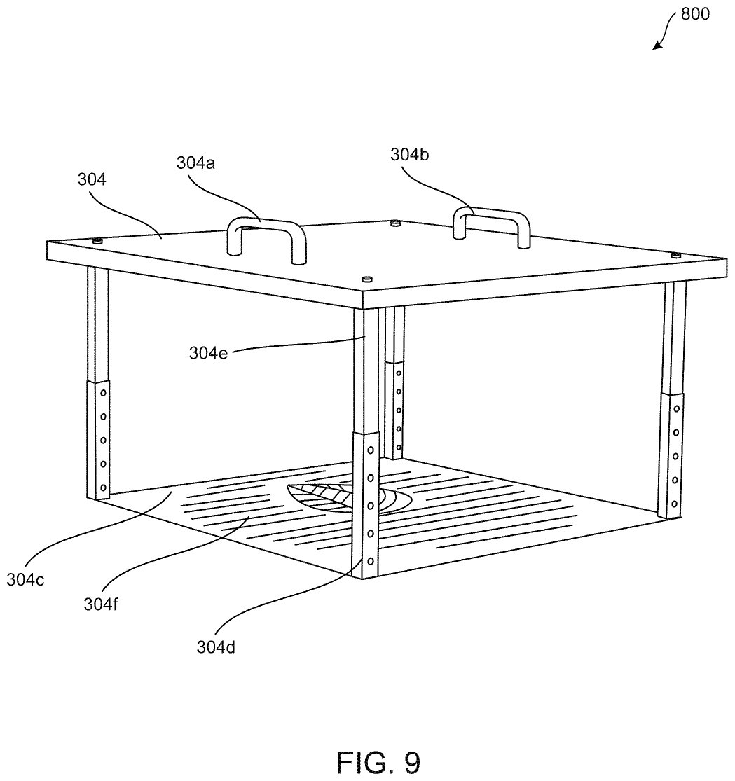

FIGS. 8 and 9 are diagrams 800 that illustrate the retractable mechanism of the lid 304, according to an exemplary embodiment of the present invention. Construction materials of the lid 304 are important because they help maintain the system cold. It keeps the water cold. The lid 304 helps the flower remain submerged under the cold water. It will keep the flower underwater, to ensure they will soak properly. The lid 304 includes two handles 304a and 304b. The lid 304 further includes four stretchable or retractable or expandable legs 304d. The lid 304 further includes a stainless-steel plate 304c having one or more patterns of openings. As shown in FIG. 8, the legs 304d of the lid 304 are at an original position where they are not stretched. In FIG. 9, the legs 304d of the lid 304 are at a stretched position as per the needs. The stretching position may be adjusted manually as per the needs during soaking process. Generally, each leg includes a hollow metallic portion 304d and a wooden portion 304e. The wooden portion 304e is designed to be inserted into the hollow metallic portion 304d as shown in FIG. 8. The metallic portion 304d includes a plurality of holes for supporting the manual extension of the legs. Each leg's expansion may be supported by using a bolt and inserting it into a right hole. Post that, the movement of the legs are restricted and can be used as per the needs.

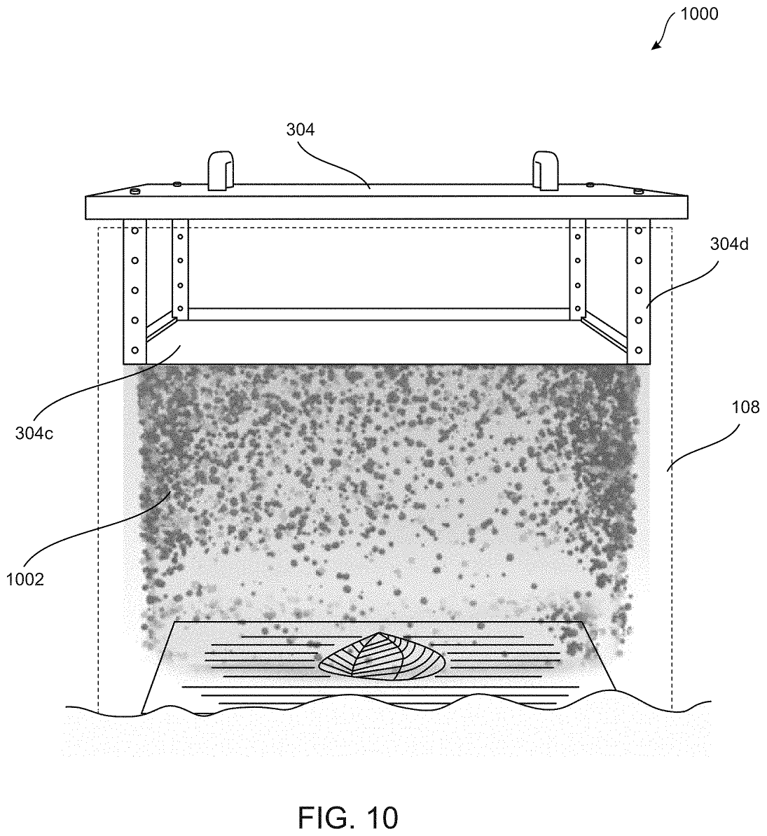

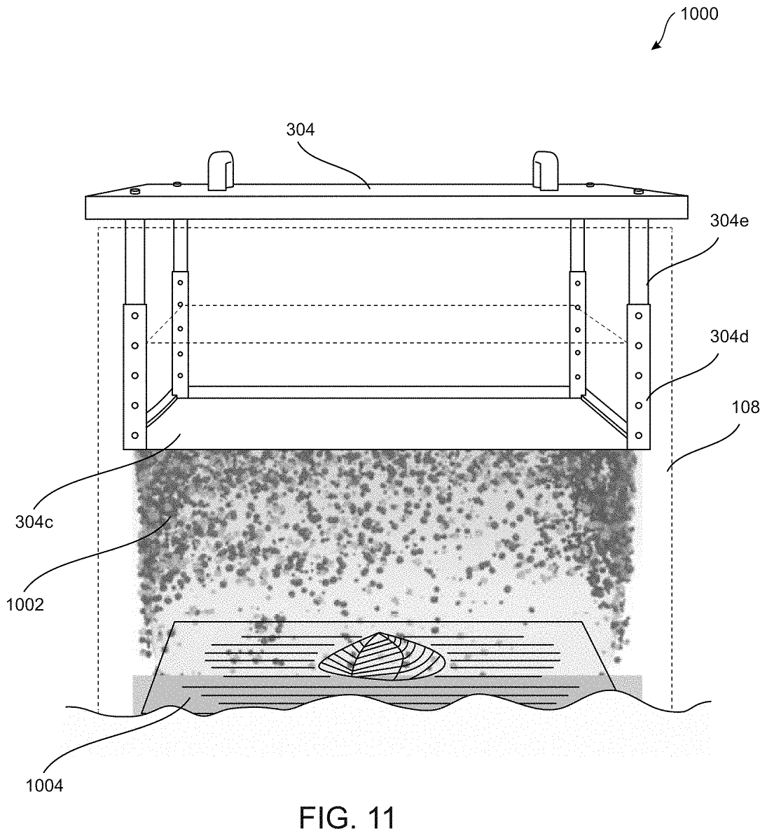

FIGS. 10 and 11 are diagrams 1000 that illustrate the retractable mechanism of the lid 304 inside the tank 108, according to an exemplary embodiment of the present invention. The lid 304 may be used for compressing plant materials (i.e., flowers) 1002 into the mixture of water and ice inside the tank 108 so that the plant materials 1002 are soaked properly. During this process, the height of each leg of the lid 304 is adjusted manually (see FIG. 11), and then the lid 304 is used to press and cover a top opening of the tank 108. Due to the increased pressure through the stainless-steel plate 304c of the lid 304, the plant materials 1002 are soaked more efficiently.

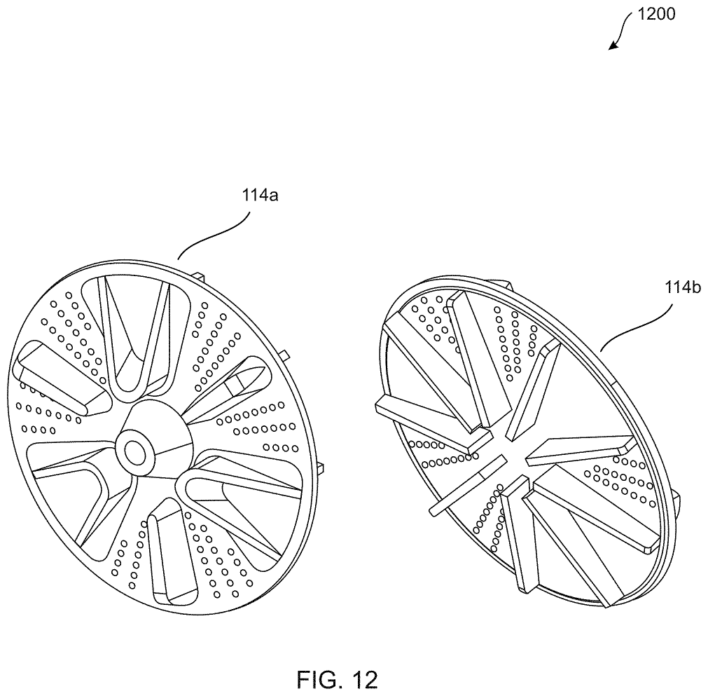

FIG. 12 is a diagram 1200 that illustrates the pulsator 114 of the agitator of the apparatus, according to an exemplary embodiment of the present invention. The pulsator 114 creates fluid currents in an upwards and downwards direction. Top portion 114a pushes fluid up and bottom portion 114b pushes fluid down. It has been seen here that the bottom portion 114b of the pulsator 114 generates less fluid flow than the top portion 114a.

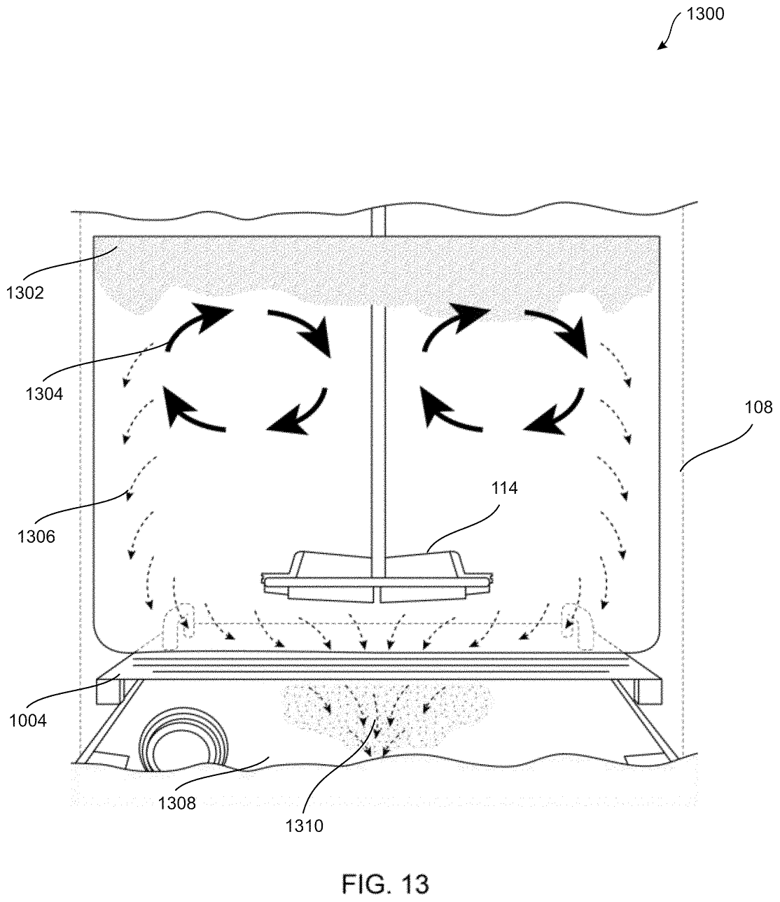

FIG. 13 is a diagram 1300 that illustrates plant processing and trichomes extraction, according to an exemplary embodiment of the present invention. As shown, during the agitation of the plant materials 1302 by the agitator 114 inside the tank 108, flowers or plant materials 1304, and trichomes 1306 are separated and do not mix with each other. The trichomes 1306 pass through the openings of the false bottom plate 1004 and reaches and settles down on the sloped V-shaped bottom surface 1308 of the tank 108. Post the collection of the trichomes 1310, the tank 108 is swapped with another tank and the collected trichomes are drained out to another collection vessel.

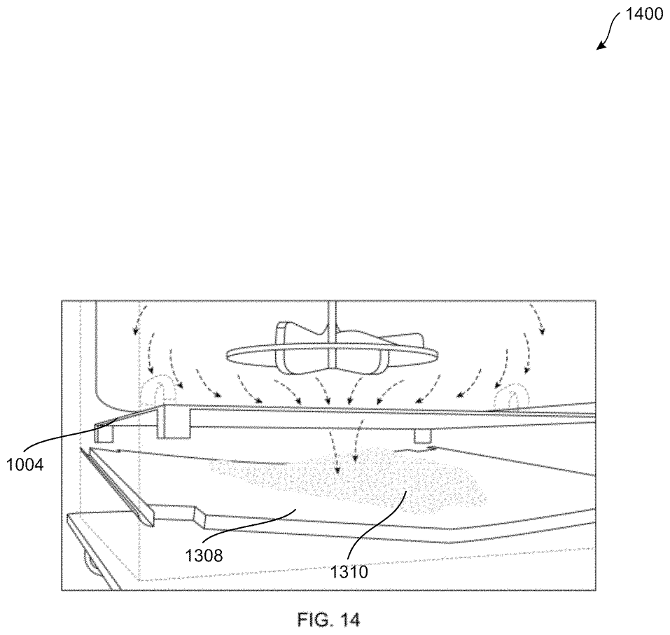

FIG. 14 is a diagram that illustrates collection of trichomes 1310, according to an exemplary embodiment of the present invention. The trichomes 1310 are collected on the sloped V-shaped bottom surface 1308 which is below the false bottom plate 1004 in the same tank 108. The V-shape is formed exactly at the center of this bottom surface 1308.

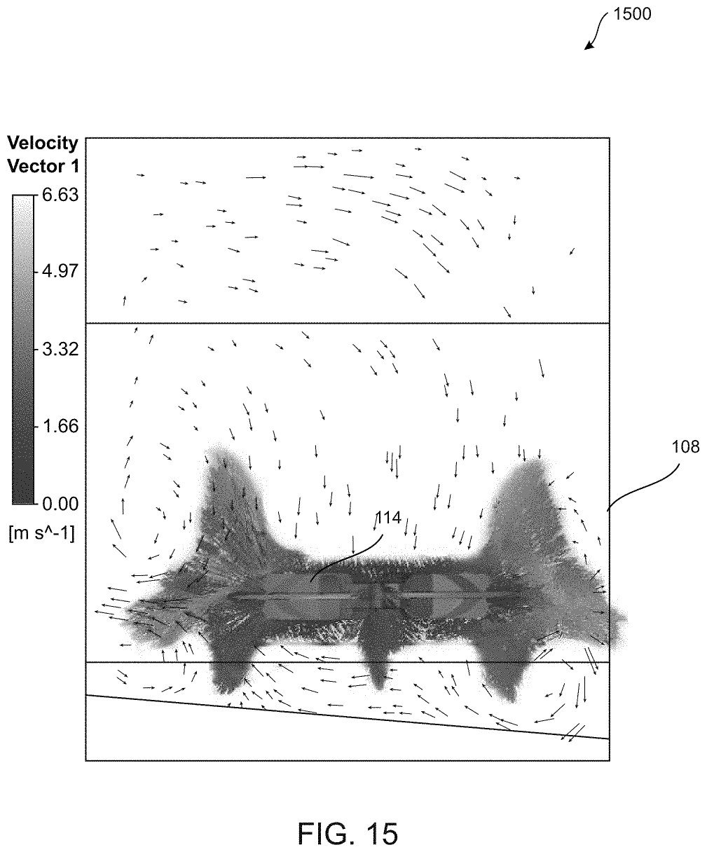

FIG. 15 is a diagram that illustrates turbulence distribution in the square tank 108 during the agitation, according to an exemplary embodiment of the present invention. Generally, the round tank generates a very uniform rotational flow with a conical air water interface. The regularity of its shape reduces the creation of turbulence at the interface, instead generating a vortex unless other design elements are implemented. The square tank generates a much more turbulent interface. Its four corners generate local flow disturbances that trigger secondary flows. These are propagated downstream by the overall rotating current and end up interacting with other corners, creating turbulence, ripples, and transient mixing of the flow at all levels, not only at the interface. In comparison to the round tank, the radial and tangential component of speed wildly change throughout the interface, triggering higher mixing of whatever rests at the interface (flowers or plant materials).

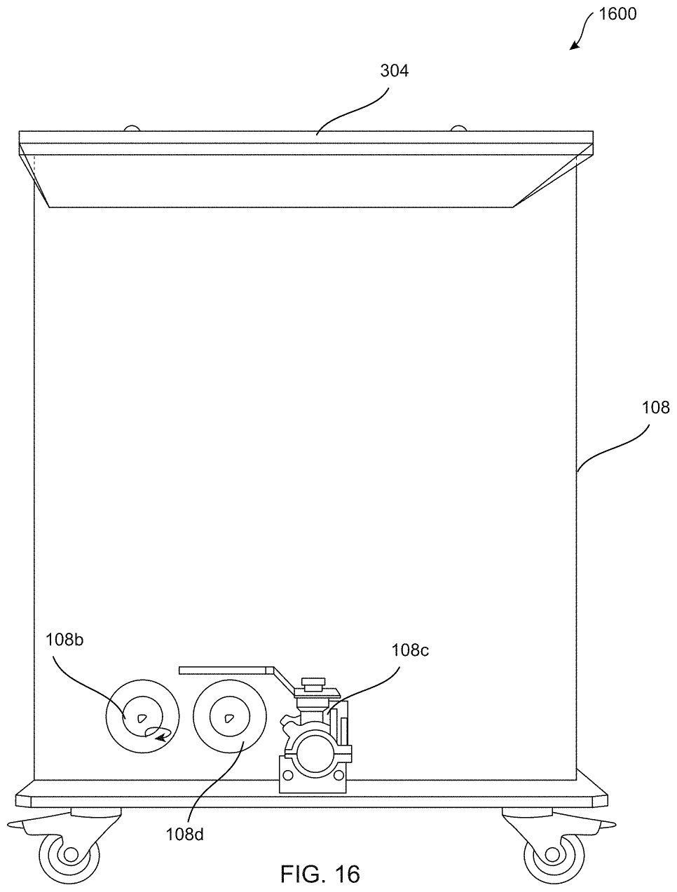

FIG. 16 is a diagram that illustrates a front view of the tank 108, according to an exemplary embodiment of the present invention. The tank 108 includes the lid 304 that is used to cover or close a top opening of the tank 108. The tank 108 further includes the sight glass 108b that can be used to inspect the inside of the tank 108. The tank 108 further includes the drain valve 108c that can be used to drain out the collected trichomes from the tank 108. The tank 108 further includes a thermometer 108d that is used to measure the inside temperature of the tank 108. The thermometer 108d may be used to verify the fluid process temperature. If the solution in the tank 108 is getting hotter, steps may be taken to modify the process temperature, such as by adding ice.

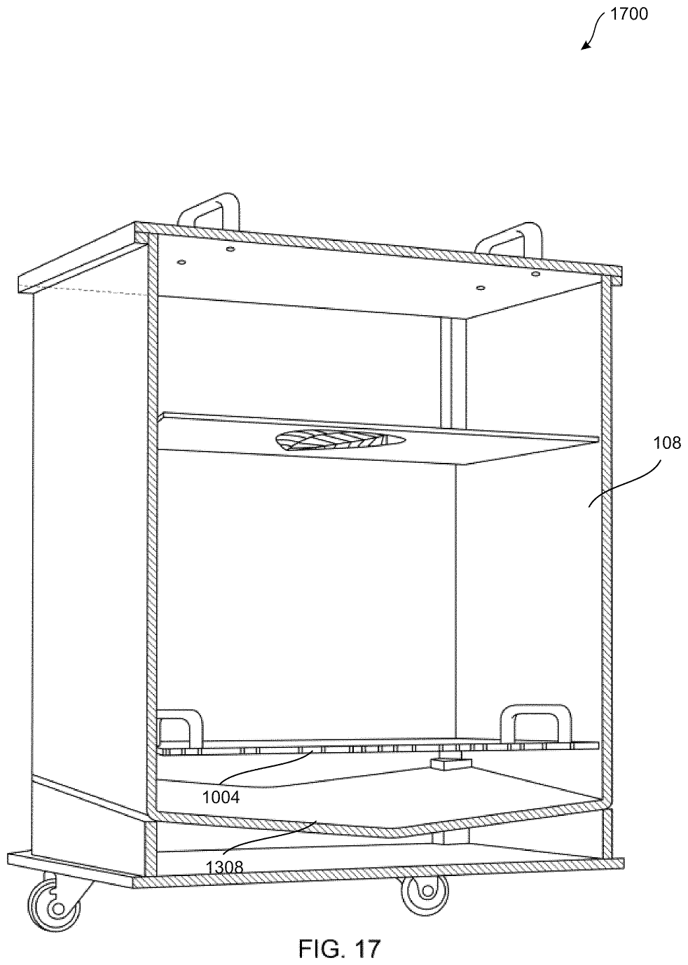

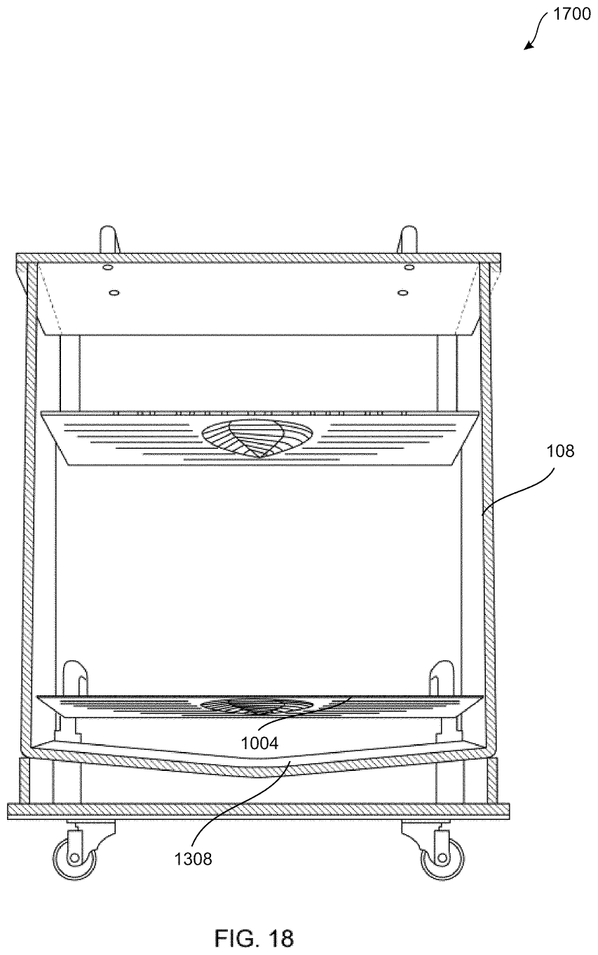

FIGS. 17 and 18 are diagrams 1700 that illustrate an inside view of the tank 108, according to an exemplary embodiment of the present invention. The tank 108 is a square tank and is made of one piece of plastic that is sloped and folded (V-shaped) at the bottom. The tank 108 includes the false bottom surface 1004 (stainless steel plate with predefined patterns of openings) and the sloped V-shaped bottom surface 1308. The tank 108 has been designed in a way that it can be easily separated and replaced by another tank. This increases the overall efficiency of the resin extraction process.

Overall, the apparatus for resin extraction, the agitation tank 108 having an open top and an outlet at a bottom thereof. The apparatus further uses the bag 602 installed within the agitation tank 108. The apparatus further comprises the agitator comprising the motor 116 which turns the shaft 112 and having the pulsator 114 mounted on the shaft 112. After soaking process is over, the agitator is used to agitate or mix the soaked flowers or plant materials in the tank 108. Here, a portion of the agitator (i.e., the pulsator 114 and a portion of the shaft 112) goes inside the tank 108 and creates one or more types of motions that causes extraction of trichomes from the flowers soaked in the tank 108. As a result of agitation, the trichomes get separated and pass-through openings of a false bottom surface (shown later) and are collected on a V-shaped bottom surface (shown later) of the tank 108. This collection of the trichomes on the V-shaped bottom surface ensures that the trichomes do not move or go upward. The false bottom surface or plate 1004 ensures that the trichomes are not getting hit by the agitator again post their collection on the V-shaped bottom surface. Once all the trichomes have been collected, the tank 108 may be replaced with another tank including soaked flowers or plant materials. This way production can continue to subsequent batches and production does not halt. The user can simply replace one tank with another tank. This process may continue to increase the overall efficiency of trichomes extraction.

Techniques consistent with the disclosure provide, among other features, the apparatus for resin extraction. While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Although particular embodiments of the invention have been described in detail for purposes of illustration, various modifications and enhancements may be made without departing from the spirit and scope of the invention. The scope of the invention is accordingly defined by the following claims.

What is claimed is:

1. An apparatus for resin extraction, comprising:
a square tank made of a plastic material,
wherein the square tank is used for agitation of plant materials; and
an agitator having a shaft, motor, and a pulsator,
wherein the motor drives the shaft which drives the pulsator for agitating the plant materials inside the tank.

2. The apparatus of claim 1, wherein the square tank comprises a lid for covering a top opening of the square tank.

3. The apparatus of claim 2, wherein the lid includes a plurality of legs and a stainless-steel plate, and wherein the plurality of legs are retractable or expandable up or down.

4. The apparatus of claim 1, wherein the square tank further comprises a bag that is a strainer basket comprising walls constructed from a mesh material selected based on a type of plant materials to be processed.

5. The apparatus of claim 1, wherein the square tank further comprises a false bottom plate that is a stainless-steel plate having defined patterns of openings that allow the trichomes to pass through it.

6. The apparatus of claim 5, wherein the square tank further comprises a sloped V-shaped bottom surface that is included for collecting the extracted trichomes as they are passing through the openings in the false bottom plate.

7. The apparatus of claim 6, wherein the false bottom plate ensures that the trichomes are not getting hit by the agitator again post their collection on the V-shaped bottom surface.

8. The apparatus of claim 1, wherein the square tank further comprises a sight glass that can be used to inspect the inside of the tank.

9. The apparatus of claim 1, wherein the square tank further comprises a drain valve that can be used to drain out the collected trichomes from the tank.

10. The apparatus of claim 1, wherein the square tank further comprises a thermometer that can be used to measure the inside temperature of the tank, wherein the thermometer can be used to verify the fluid process temperature and if the solution in the tank is getting hotter, steps may be taken to modify the process temperature, such as adding ice.
